(19) United States
(12) Patent Application Publication
(10) Pub. No.: US 2018/0175745 A1
(43) Pub. Date: Jun. 21, 2018

(54) WEARABLE DEVICE AND MANUFACTURING METHOD THEREOF

(71) Applicant: BOE TECHNOLOGY GROUP CO., LTD., Beijing (CN)

(72) Inventors: Lin Zhu, Beijing (CN); Wenbo Li, Beijing (CN)

(21) Appl. No.: 15/112,922

(22) PCT Filed: Feb. 26, 2016
(86) PCT No.: PCT/CN2016/074644

§ 371 Date: Jul. 20, 2016

(30) Foreign Application Priority Data
Sep. 7, 2015 (CN) 201510564771.8

(51) Int. Cl. H02N 1/04; H01M 4/02; H01M 2/02

(52) U.S. Cl. CPC H02N 1/04; H01M 4/02; H01M 2220/30; H01M 2/025; H01M 2/0277

(57) ABSTRACT

A wearable device and manufacturing method thereof are disclosed. The wearable device comprises a fixing band and a wearable device body connected to the fixing band; the fixing band is configured to generate power under stress; the power generated by the fixing band is transferable to the wearable device body to supply power to the wearable device body; the fixing band and the wearable device body form an enclosure.

### CROSS REFERENCE TO RELATED APPLICATIONS

This application is a National Stage Entry of PCT/CN2016/074644, filed Feb. 26, 2016, which claims the benefit and priority of Chinese Patent Application No. 201510564771.8, filed Sep. 7, 2015. The entire disclosure of each of the above applications are incorporated herein by reference.

### BACKGROUND

Embodiments of the present disclosure relate generally to wearable devices, and in particular to a wearable device and manufacturing method thereof.

A wearable device is a portable device capable of being directly worn on the body, or integrated on the clothes or accessories of a user. The wearable device is not only a hardware device, but also achieves powerful functions through software support as well as data exchange and cloud interaction.

In the prior art, a wearable device generally includes a fixing band and a wearable device body, wherein the fixing band and the wearable device body form an enclosed circle; the fixing band is for wearing the wearable device on the body of a user; and the wearable device body is provided with a battery within for supplying power to the wearable device. With the rapid development of the science and technology, the volume of the wearable device body becomes smaller and smaller, and so does the volume of the battery in the wearable device body. Since the functions of the wearable device are increasingly powerful, the user also has higher and higher requirement for the quantity of electricity stored in the battery.

Since the battery in the wearable device body has a small volume, the quantity of electricity stored in the battery is small, and the power supplied by the battery for the wearable device is also small. In addition, when the electricity of the battery is exhausted, a new battery is required or the battery should be charged with a charger to ensure the normal operation of the wearable device. Therefore, the power supply capability of the battery is poor and the cost is high.

### BRIEF DESCRIPTION

The present disclosure provides a wearable device and manufacturing method thereof.

In a first aspect, there is provided a wearable device, comprising a fixing band and a wearable device body connected to the fixing band;

the fixing band is configured to generate power under stress;

the power generated by the fixing band is transferable to the wearable device body to supply power to the wearable device body; in some embodiments, the fixing band and the wearable device body form an enclosure.

Optionally, the wearable device body is provided with a conductor at a position capable of contacting the skin of the wearer, the conductor being used for receiving the power generated by the fixing band and transferred through the skin of the wearer.

Optionally, the conductor is disposed at the connection between the fixing band and the wearable device body, and the fixing band transfers the power generated by the fixing band to the wearable device body through the conductor.

Optionally, the fixing band comprises at least one power generation module, each power generation module comprising:

at least two macromolecular insulating layers;

and at least one electrode formed on the at least two macromolecular insulating layers.

Optionally, the fixing band comprises one power generation module; the at least two macromolecular insulating layers comprise a first macromolecular insulating layer and a second macromolecular insulating layer; and the at least one electrode comprises a first electrode;

the first macromolecular insulating layer contacts the skin of the wearer in some embodiments;

the second macromolecular insulating layer is formed on the first macromolecular insulating layer, and does not contact the first macromolecular insulating layer;

the first electrode is formed on the second macromolecular insulating layer.

Optionally, a first protective film is formed on the first electrode.

Optionally, the fixing band comprises at least two power generation modules, and further comprises:

a second protective film;

the at least two power generation modules being formed on one side of the second protective film.

Optionally, the at least two macromolecular insulating layers comprise a third macromolecular insulating layer and a fourth macromolecular insulating layer; and the at least one electrode comprises a second electrode.

each power generation module comprises:

the third macromolecular insulating layer;

the second electrode is formed on one side of the third macromolecular insulating layer;

the fourth macromolecular insulating layer is formed at one end on the side of the second electrode facing away from the third macromolecular insulating layer;

each power generation module bends towards the center of the third macromolecular insulating layer and forms a C-shaped structure; the C-shaped openings of any two adjacent power generation modules facing each other, and one end of one power generation module extends into the C-shaped opening of the other power generation module; the any two adjacent power generation modules do not contact each other, and the end of any one power generation module where the fourth macromolecular insulating layer is formed does not contact the second protective film.

Optionally, a fifth macromolecular insulating layer is disposed between the any two adjacent power generation modules; the at least two macromolecular insulating layers comprise a sixth macromolecular insulating layer and a seventh macromolecular insulating layer; the at least one electrode comprises a third electrode and a fourth electrode; and each power generation module comprises:

the third electrode;

the sixth macromolecular insulating layer is formed on the third electrode;

the seventh macromolecular insulating layer is formed on the sixth macromolecular insulating layer, and does not contact the sixth macromolecular insulating layer;

the fourth electrode is formed on the seventh macromolecular insulating layer.

Optionally, a first protective film is formed on the at least two power generation modules.

Optionally, a counterweight layer is formed on the first protective film, and is for applying pressure on the first protective film.

Optionally, the wearable device body comprises a battery and a voltage processing module;

the voltage processing module is configured to transfer the power received by the conductor to the battery;

the battery is configured to store the power, and to supply the power to the wearable device body.

Optionally, the voltage processing module comprises a voltage lowering sub-module, a rectification sub-module and a buck circuit, the voltage lowering sub-module being electrically connected to the conductor and the rectification sub-module respectively, and the buck circuit being electrically connected to the rectification sub-module and the battery respectively;

the voltage lowering sub-module is configured to lower the output voltage received by the conductor to obtain a lowered AC voltage;

the rectification sub-module is configured to rectify the lowered AC voltage to obtain a DC voltage;

and the buck circuit is configured to lower the DC voltage to obtain a lowered DC voltage, and to transfer the lowered DC voltage to the battery.

Optionally, the voltage lowering sub-module comprises at least one transformer.

In a second aspect, there is provided a wearable device manufacturing method, the method comprising:

manufacturing a fixing band capable of generating power under stress;

providing a wearable device body;

connecting the fixing band with the wearable device body, enabling the power generated by the fixing band to be transferred to the wearable device body to supply power to the wearable device body, the fixing band and the wearable device body being capable of forming an enclosure.

Optionally, after providing the wearable device body, the method further comprises:

disposing a conductor on the wearable device body at a position capable of contacting the skin of the wearer, the conductor being capable of receiving the power generated by the fixing band and transferred through the skin of the wearer.

Optionally, after providing the wearable device body, the method further comprises:

disposing a conductor at the connection between the fixing band and the wearable device body, the fixing band being capable of transferring the power generated by the fixing band to the wearable device body through the conductor.

Optionally, the manufacturing the fixing band comprises:

manufacturing at least one power generation module;

wherein the manufacturing the at least one power generation module comprises:

forming at least two macromolecular insulating layers;

forming at least one electrode on the at least two macromolecular insulating layers.

Optionally, the fixing band comprises one power generation module; the at least two macromolecular insulating layers comprise a first macromolecular insulating layer and a second macromolecular insulating layer; the at least one electrode comprises a first electrode; and the first macromolecular insulating layer is positioned to contact the skin of the wearer,

the manufacturing the fixing band comprises:

forming the second macromolecular insulating layer on the first macromolecular insulating layer, wherein the second macromolecular insulating layer does not contact the first macromolecular insulating layer;

forming the first electrode on the second macromolecular insulating layer.

Optionally, after forming the first electrode on the second macromolecular insulating layer, the manufacturing the fixing band further comprises:

forming a first protective film on the first electrode.

Optionally, the fixing band comprises at least two power generation modules, and the manufacturing the fixing band further comprises:

forming a second protective film;

forming the at least two power generation modules on one side of the second protective film.

Optionally, the at least two macromolecular insulating layers comprise a third macromolecular insulating layer and a fourth macromolecular insulating layer; and the at least one electrode comprises a second electrode,

the forming each power generation module comprises:

forming the third macromolecular insulating layer;

forming the second electrode on one side of the third macromolecular insulating layer;

forming the fourth macromolecular insulating layer at one end on the side of the second electrode facing away from the third macromolecular insulating layer;

the manufacturing the fixing band further comprises:

bending each power generation module towards the center of the third macromolecular insulating layer and forming a C-shaped structure, the C-shaped openings of any two adjacent power generation modules facing each other, and one end of one power generation module extending into the C-shaped opening of the other power generation module;

wherein the any two adjacent power generation modules do not contact, and the end of any one power generation module where the fourth macromolecular insulating layer is formed does not contact the second protective film.

Optionally, a fifth macromolecular insulating layer is disposed between the any two adjacent power generation modules; the at least two macromolecular insulating layers comprise a sixth macromolecular insulating layer and a seventh macromolecular insulating layer; the at least one electrode comprises a third electrode and a fourth electrode;

the forming each power generation module comprises:

forming the third electrode;

forming the sixth macromolecular insulating layer on the third electrode;

forming the seventh macromolecular insulating layer on the sixth macromolecular insulating layer, wherein the seventh macromolecular insulating layer does not contact the sixth macromolecular insulating layer;

forming the fourth electrode on the seventh macromolecular insulating layer.

Optionally, after forming the at least two power generation modules on one side of the second protective film, the manufacturing the fixing band further comprises:

forming a first protective film on the at least two power generation modules.

Optionally, the manufacturing the fixing band further comprises:

forming a counterweight layer on the first protective film, the counterweight layer being capable of applying pressure on the first protective film.

The present disclosure provides a wearable device and manufacturing method thereof. The wearable device comprises a fixing band and a wearable device body connected to the fixing band, wherein the fixing band is configured to generate power under stress, and the power generated by the fixing band is transferable to the wearable device body to supply power to the wearable device body, thus improving the capability of supplying power to the wearable device body, and reducing the cost.

It should be understood that the general description above and the detailed description hereinafter are for illustration and explanation only, but not for restricting the present disclosure.

### BRIEF DESCRIPTION OF THE DRAWINGS

In order to clearly explain the present disclosure, the drawings required in description of the embodiments will be introduced briefly hereinafter. Obviously, the drawings in the specification are only some embodiments of the present disclosure. For those ordinarily skilled in the art, other drawings can be obtained based on these drawings without paying creative effort.

FIG. 1 is a structural schematic diagram of a wearable device provided by an embodiment of the present disclosure;

FIG. 2 is a structural schematic diagram of an arrangement of a conductor provided by an embodiment of the present disclosure;

FIG. 3 is a structural schematic diagram of an arrangement of another conductor provided by an embodiment of the present disclosure;

FIG. 4A is a structural schematic diagram of a fixing band provided by an embodiment of the present disclosure;

FIG. 4B is a structural schematic diagram of a wearable device provided by an embodiment of the present disclosure;

FIG. 5 is a structural schematic diagram of another fixing band provided by an embodiment of the present disclosure;

FIG. 6 is a structural schematic diagram of yet another fixing band provided by an embodiment of the present disclosure;

FIG. 7 is a structural schematic diagram of a further fixing band provided by an embodiment of the present disclosure;

FIG. 8 is a structural schematic diagram of a wearable device body provided by an embodiment of the present disclosure;

FIG. 9 is a structural schematic diagram of a voltage processing module provided by an embodiment of the present disclosure;

FIG. 10 is a flowchart of a wearable device manufacturing method provided by an embodiment of the present disclosure;

FIG. 11A is a flowchart of another wearable device manufacturing method provided by an embodiment of the present disclosure;

FIG. 11B is a flowchart of a manufacturing process of each power generation module provided by an embodiment of the present disclosure;

FIG. 11C is a flowchart of a fixing band manufacturing process provided by an embodiment of the present disclosure;

FIG. 11D is a structural schematic diagram of formation of a second macromolecular insulating layer provided by an embodiment of the present disclosure;

FIG. 11E is a structural schematic diagram of formation of a first electrode provided by an embodiment of the present disclosure;

FIG. 11F is a structural schematic diagram of formation of a first protective film provided by an embodiment of the present disclosure;

FIG. 11G is a flowchart of another fixing band manufacturing process provided by an embodiment of the present disclosure;

FIG. 11H is a structural schematic diagram of formation of a second protective film provided by an embodiment of the present disclosure;

FIG. 11I is an another structural schematic diagram of formation of a first protective film provided by an embodiment of the present disclosure;

FIG. 11J is an another structural schematic diagram of formation of a counterweight layer provided by an embodiment of the present disclosure;

FIG. 11K is a flowchart of another manufacturing process of each power generation module provided by an embodiment of the present disclosure;

FIG. 11L is a structural schematic diagram of formation of a third macromolecular insulating layer provided by an embodiment of the present disclosure;

FIG. 11M is a structural schematic diagram of formation of a second electrode provided by an embodiment of the present disclosure;

FIG. 11N is a structural schematic diagram of formation of a fourth macromolecular insulating layer provided by an embodiment of the present disclosure;

FIG. 11O is a structural schematic diagram of a power generation module provided by an embodiment of the present disclosure;

FIG. 11P is a flowchart of a yet another manufacturing process of each power generation module provided by an embodiment of the present disclosure;

FIG. 11Q is a structural schematic diagram of formation of a third electrode provided by an embodiment of the present disclosure;

FIG. 11R is a structural schematic diagram of formation of a sixth macromolecular insulating layer provided by an embodiment of the present disclosure;

FIG. 11S is a structural schematic diagram of formation of a seventh macromolecular insulating layer provided by an embodiment of the present disclosure;

FIG. 11T is a structural schematic diagram of formation of a fourth electrode provided by an embodiment of the present disclosure.

The specific embodiments of the present disclosure have been presented through the above drawings, and will be described in more detail hereinafter. These drawings and textual description are used for explaining for those skilled in the art the concept of the present disclosure with reference to the specific embodiments, and not for restricting the scope of the concept of the present disclosure in any way.

### DETAILED DESCRIPTION

To make the present disclosure more clear, embodiments of the present disclosure will be described hereinafter in conjunction with the drawings.

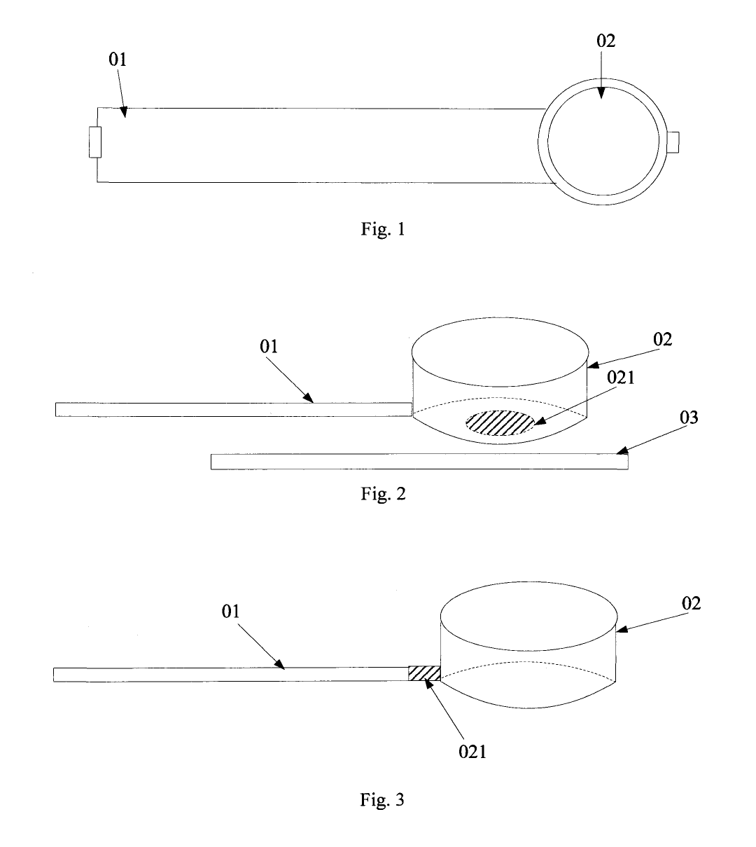

An embodiment of the present disclosure provides a wearable device. As shown in FIG. 1, the wearable device comprises a fixing band 01 and a wearable device body 02 connected to the fixing band 01.

The fixing band 01 is configured to generate power under stress.

The power generated by the fixing band 01 may be transferred to the wearable device body 02 to supply power to the wearable device body 02; the fixing band 01 and the wearable device body 02 may form an enclosure; and the fixing band 01 is configured to enable wearing of the wearable device on the body of a user.

To summarize, there is provided in an embodiment of the present disclosure a wearable device. The wearable device comprises a fixing band and a wearable device body connected to the fixing band, wherein the fixing band is configured to generate power under stress, and the power generated by the fixing band may be transferred to the wearable device body to supply power to the wearable device body, thus improving the capability of supplying power to the wearable device body, and reducing the cost.

Optionally, as shown in FIG. 2, the wearable device body 02 is provided with a conductor 021 at a position capable of contacting the skin of the wearer, the conductor 021 being for receiving the power generated by the fixing band 01 and transferred through the skin 03 of the wearer. The power generated by the fixing band is transferred to the wearable device body through the skin of the wearer and the conductor, so as to supply power to the wearable device body.

Optionally, as shown in FIG. 3, a conductor 021 may also be disposed at the connection between the fixing band 01 and the wearable device body 02, and the fixing band 01 transfers the power generated by the fixing band to the wearable device body 02 through the conductor 021. The power generated by the fixing band is directly transferred to the wearable device body through the conductor, so as to supply power to the wearable device body.

Optionally, the fixing band comprises at least one power generation module, and each power generation module comprises at least two macromolecular insulating layers, and at least one electrode formed on the at least two macromolecular insulating layers. Each power generation module comprises macromolecular insulating layers and electrodes, therefore, when the fixing band is under stress, the macromolecular insulating layers will become deformed and contact the electrodes, and the two electrodes will generate electrons and then generate potential difference, such that the fixing band can generate power and supply power to the wearable device body. It should be indicated that when the power generation module comprises one electrode, the skin of the wearer can act as another electrode. When the user moves wearing the wearable device, the fixing band will come close to the body, and the macromolecular insulating layers in the fixing band will become deformed, contact and induce the electrode to generate electrons. In the meanwhile, the human body is also a conductor, so after becoming deformed, the macromolecular insulating layers will also contact and induce the skin to generate electrons, the electrons generated by the skin being the electrons transferred to the human body from the ground. Finally, the electrode in the fixing band and the skin generate potential difference, and the fixing band generates power which may be transferred to the wearable device to supply power to the wearable device body through the conductor disposed on the wearable device body at the position capable of contacting the skin of the wearer, or the conductor disposed at the connection between the fixing band and the wearable device body, wherein the macromolecular insulating layers may be made of a flexible material or an inflexible material.

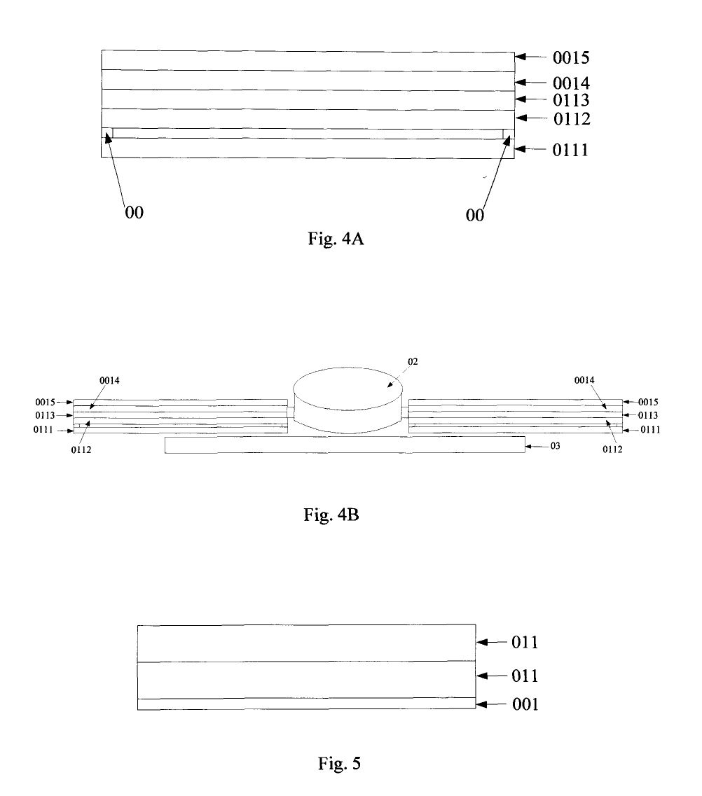

FIG. 4A illustrates the fixing band comprising one power generation module. As shown in FIG. 4A, the at least two macromolecular insulating layers comprises a first macromolecular insulating layer 0111 and a second macromolecular insulating layer 0112; and the at least one electrode comprises a first electrode 0113. The first macromolecular insulating layer 0111 may contact the skin of the wearer; the second macromolecular insulating layer 0112 is formed on the first macromolecular insulating layer 0111, and does not contact the first macromolecular insulating layer 0111; the first electrode 0113 is formed on the second macromolecular insulating layer 0112. For example, as shown in FIG. 4A, the second macromolecular insulating layer 0112 and the first macromolecular insulating layer 0111 may be isolated by an isolator 00, such that the second macromolecular insulating layer 0112 does not contact the first macromolecular insulating layer 0111.

As shown in FIG. 4A, a first protective film 0014 may also be formed on the first electrode 0113. The first protective film 0014 is for protecting the fixing band, such that the fixing band is not easy to be damaged. In addition, a counterweight layer 0015 may also be formed on the first protective film 0014. The counterweight layer 0015 is configured to apply pressure on the first protective film 0014, making the first macromolecular insulating layer fully contact the skin of the wearer, and the second macromolecular insulating layer fully contact the first electrode, such that the skin and the first electrode may generate more electrons, thus improving the power generation capability of the fixing band, and improving the capability of supplying power to the wearable device. The counterweight layer may be a thick plate formed on the first protective film. For example, the counterweight layer may be made of a metal material. FIG. 4B illustrates a structural schematic diagram of a wearable device comprising the fixing band as shown in FIG. 4A. In FIG. 4B, 0111 is the first macromolecular insulating layer; 0112 is the second macromolecular insulating layer; 0113 is the first electrode; 0014 is the first protective film; 0015 is the counterweight layer; 02 is the wearable device body; and 03 is the skin of the wearer. The fixing band as shown in FIG. 4B comprises two band sections. In practical application, the fixing band may also comprise one band section. Embodiments of the present disclosure have no limitation in this respect.

In order to improve the quantity of electricity and the power generation capability of the fixing band, and make the fixing band better supply power to the wearable device body, the fixing band, for example, may comprise at least two power generation modules. As shown in FIG. 5, the fixing band may further comprise a second protective film 001; at least two power generation modules 011 are formed on one side of the second protective film 001.

It needs to be indicated that the fixing band as shown in FIG. 5 comprises two power generation modules. In practical application, in order to further improve the power generation capability of the fixing band, the fixing band may also comprise more than two power generation modules.

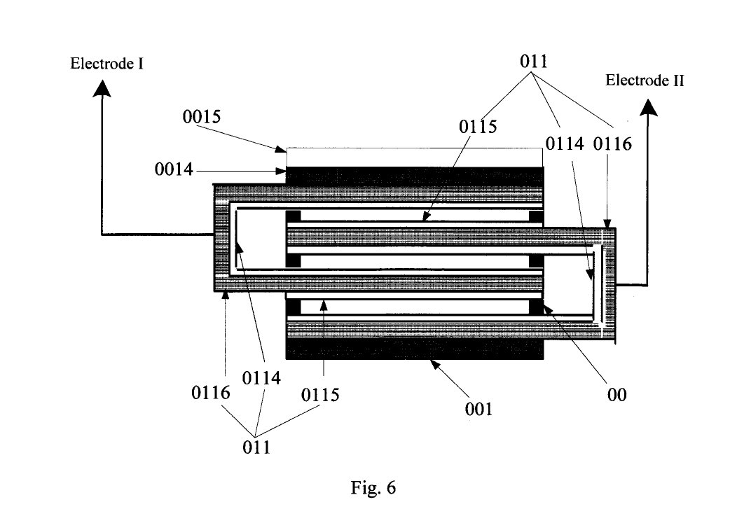

Optionally, FIG. 6 illustrates a specific structural schematic diagram of the fixing band as shown in FIG. 5. As shown in FIG. 6, the at least two macromolecular insulating layers comprise a third macromolecular insulating layer 0114 and a fourth macromolecular insulating layer 0115; and the at least one electrode comprises a second electrode 0116.

Therein each power generation module 011 comprises the third macromolecular insulating layer 0114; the second electrode 0116 is formed on one side of the third macromolecular insulating layer 0114; the fourth macromolecular insulating layer 0115 is formed at one end on the side of the second electrode 0116 facing away from the third macromolecular insulating layer 0114. Each power generation module 011 bends towards the center of the third macromolecular insulating layer 0114 and forms a C-shaped structure; the C-shaped openings of any two adjacent power generation modules are facing each other, and one end of one power generation module extends into the C-shaped opening of the other power generation module; the any two adjacent power generation modules do not contact each other, and the end of any one power generation module where the fourth macromolecular insulating layer 0115 is formed does not contact the second protective film 001. For example, the adjacent power generation modules may be isolated by the isolator 00. In FIG. 6, the second electrode of the power generation module with a rightward facing opening may act as one electrode, and the second electrode of the power generation module with a leftward facing opening may act as another electrode. Therefore, when the fixing band is under stress, the third macromolecular insulating layer 0114 and the fourth macromolecular insulating layer 0115 of the power generation module with a rightward facing opening become deformed; the third macromolecular insulating layer 0114 and the fourth macromolecular insulating layer 0115 respectively contact the second electrode 0116; the second electrode 0116 generates electrons, and acts as electrode I; in the same way, the third macromolecular insulating layer 0114 and the fourth macromolecular insulating layer 0115 of the power generation module with a leftward facing opening become deformed; the third macromolecular insulating layer 0114 and the fourth macromolecular insulating layer 0115 respectively contact the second electrode 0116; the second electrode 0116 generates electrons, and acts as electrode II. In this way, the two electrodes generate potential difference, and the fixing band generates power to supply power to the wearable device. When more than two power generation modules are included in FIG. 6, electrode I may comprise a plurality of electrodes, and electrode II may comprise a plurality of electrodes, such that the electrode I and the electrode II may generate more electrons, thus improving the power generation capability of the fixing band, and further improving the capability of supplying power to the wearable device.

In addition, as shown in FIG. 6, a first protective film 0014 may also be formed on the two power generation modules. The first protective film 0014 is for protecting the fixing band. A counterweight layer 0015 may also be formed on the first protective film 0014. The counterweight layer 0015 is for applying pressure on the first protective film 0014, making the third macromolecular insulating layer 0114 and the fourth macromolecular insulating layer 0115 be able to fully contact the second electrode 0116, such that the second electrode 0116 may generate more electrons, thus improving the power generation capability of the fixing band, and further improving the capability of supplying power to the wearable device body.

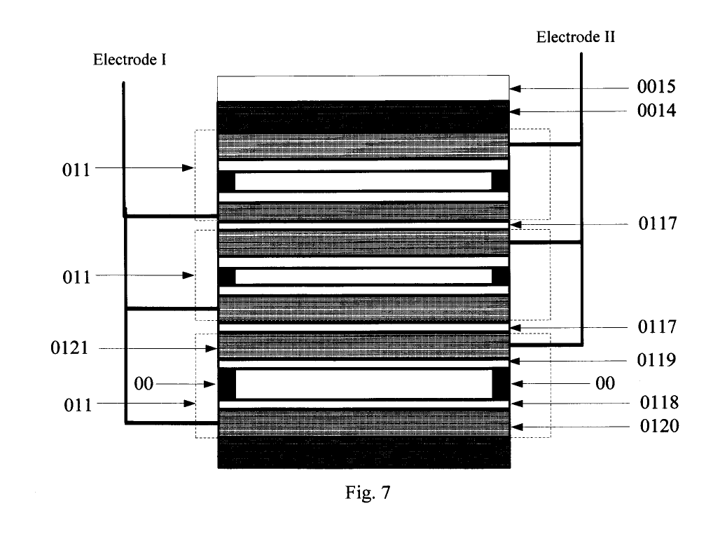

Optionally, FIG. 7 illustrates another specific structural schematic diagram of the fixing band as shown in FIG. 5. As shown in FIG. 7, a fifth macromolecular insulating layer 0117 is disposed between any two adjacent power generation modules; the at least two macromolecular insulating layers comprise a sixth macromolecular insulating layer 0118 and a seventh macromolecular insulating layer 0119; the at least one electrode comprises a third electrode 0120 and a fourth electrode 0121. Each power generation module 011 comprises the third electrode 120; the sixth macromolecular insulating layer 0118 is formed on the third electrode 0120; the seventh macromolecular insulating layer 0119 is formed on the sixth macromolecular insulating layer 0118, and does not contact the sixth macromolecular insulating layer 0118; the fourth electrode 0121 is formed on the seventh macromolecular insulating layer 0119. For example, as shown in FIG. 7, the seventh macromolecular insulating layer 0119 and the sixth macromolecular insulating layer 0118 may be isolated by an isolator 00, such that the seventh macromolecular insulating layer 0119 does not contact the sixth macromolecular insulating layer 0118. In FIG. 7, the third electrode 0120 of each power generation module may act as one electrode, and the fourth electrode 0121 may act as another electrode. Therefore, when the fixing band is under stress, the sixth macromolecular insulating layer 0118 and the seventh macromolecular insulating layer 0119 become deformed; the sixth macromolecular insulating layer 0118 contacts the third electrode 0120; the third electrode 0120 generates electrons, and acts as the electrode I. In the same way, the seventh macromolecular insulating layer 0119 contacts the fourth electrode 0121; the fourth electrode 0121 generates electrons, and acts as the electrode II, wherein the fifth macromolecular insulating layer 0117 may also contact the adjacent electrode to make the adjacent electrode generate electrons. In this way, the electrode I and the electrode II generate potential difference, and the fixing band generates power to supply power to the wearable device. Since the electrode I comprises a plurality of electrodes, and the electrode II also comprises a plurality of electrodes, the electrodes may generate more electrons after the macromolecular insulating layers contact the electrodes, and the fixing band may have a higher power generation capability and may better supply power to the wearable device body.

In addition, as shown in FIG. 7, a first protective film 0014 may also be formed on the two power generation modules. The first protective film 0014 is for protecting the fixing band, such that the fixing band is not easy to be damaged. A counterweight layer 0015 may also be formed on the first protective film 0014. The counterweight layer 0015 is for applying pressure on the first protective film 0014, making the sixth macromolecular insulating layer 0118 be able to fully contact the third electrode 0120, the seventh macromolecular insulating layer 0119 be able to fully contact the fourth electrode 0121, and the fifth macromolecular insulating layer 0117 be able to fully contact the adjacent electrode, thus further improving the capability of supplying power to the wearable device body.

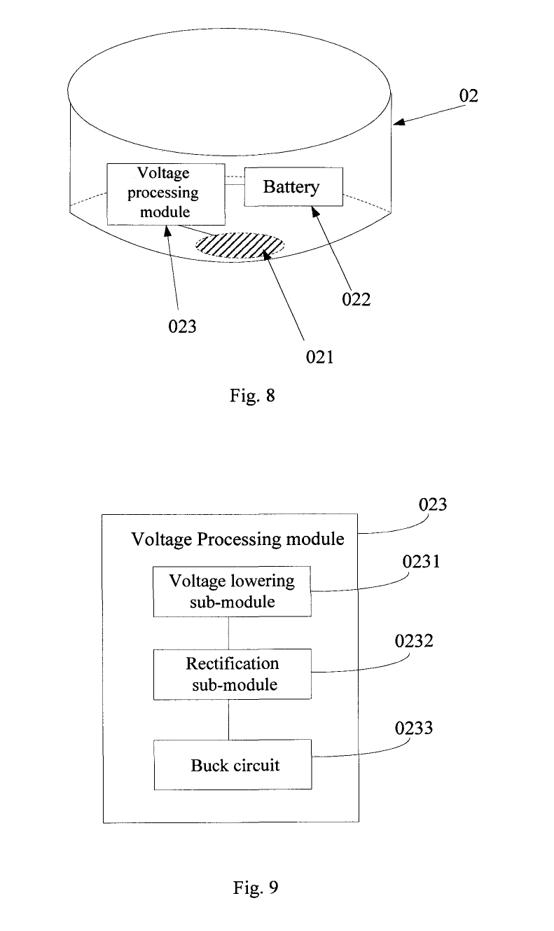

As shown in FIG. 8, the wearable device body 02 comprises a battery 022 and a voltage processing module 023, wherein the voltage processing module 023 is configured to transfer the power received by the conductor 021 to the battery 022; the battery 022 is configured to store the power, and to supply power to the wearable device body 02. The conductor as shown in FIG. 8 is disposed on the wearable device body at a position capable of contacting the skin of the wearer. Furthermore, the conductor can also be disposed at the connection between the fixing band and the wearable device body.

The output voltage received by the conductor may be a high voltage low frequency voltage, so the voltage processing module is configured to lower and rectify the output voltage received by the conductor, such that the battery may store the processed voltage and supply power to the wearable device body.

Optionally, as shown in FIG. 9, the voltage processing module 023 may comprise a voltage lowering sub-module 0231, a rectification sub-module 0232 and a buck circuit 0233, the voltage lowering sub-module 0231 being electrically connected to the conductor and the rectification sub-module 0232 respectively, and the buck circuit 0233 being electrically connected to the rectification sub-module 0232 and the battery respectively.

Therein the voltage lowering sub-module 0231 is configured to lower the output voltage received by the conductor to obtain a lowered AC voltage. The voltage lowering sub-module may comprise at least one transformer. When the voltage lowering sub-module comprises two or more transformers, the two or more transformers may be connected in parallel, so as to lower the output voltage received by the conductor in a stepwise way.

The rectification sub-module 0232 is configured to rectify the lowered AC voltage to obtain a DC voltage. Since the battery can only provide DC voltage to the wearable device body, after the voltage lowering sub-module is used to lower the output voltage received by the conductor, the rectification sub-module needs to be used to rectify the lowered AC voltage to obtain the DC voltage.

The buck circuit 0233 is configured to lower the DC voltage to obtain a lowered DC voltage, and to transfer the lowered DC voltage to the battery. In order to further lower the voltage, the buck circuit may be used to lower the obtained DC voltage.

By using the contact friction effect and static electricity induction effect between the electrode and a thin film material, namely the macromolecular insulating layer, the fixing band provided by embodiments of the present disclosure makes the macromolecular insulating layer and the electrode generate electric charges of different polarities, thus making the electrode generate electrons and the fixing band generate power, and finally supplying power to the wearable device body through the fixing band.

It needs to be added that in the prior art, when the power of the battery of the wearable device body is exhausted, the battery is charged mainly with a charger. Embodiments of the present disclosure use the thin film material to generate power, and the fixing band may generate power under stress. Therefore, as long as the user is moving, the fixing band is capable of supplying power to the wearable device body, and the battery does not need to be charged with a charger. With the continuous increase of the movement of the user, the fixing band will generate more and more power; the battery will store the power generated by the fixing band at any time; and the stored power may supply power to the wearable device body all the time. When the user does not move and the power generated by the fixing band has been exhausted, the wearable device may continue to use the battery in the wearable device body to supply power to the wearable device body. That is to say, the power supply solution provided by embodiments of the present disclosure may act as a supplementary solution to the charger, thus improving the capability of supplying power to the wearable device body, reducing the cost, and improving the power supply flexibility.

To summarize, embodiments of the present disclosure provide a wearable device. The wearable device comprises a fixing band and a wearable device body connected with the fixing band, wherein the fixing band may generate power under stress, and the power generated by the fixing band may be transferred to the wearable device body to supply power to the wearable device body, thus improving the capability of supplying power to the wearable device body, reducing the cost, and improving power supply flexibility.

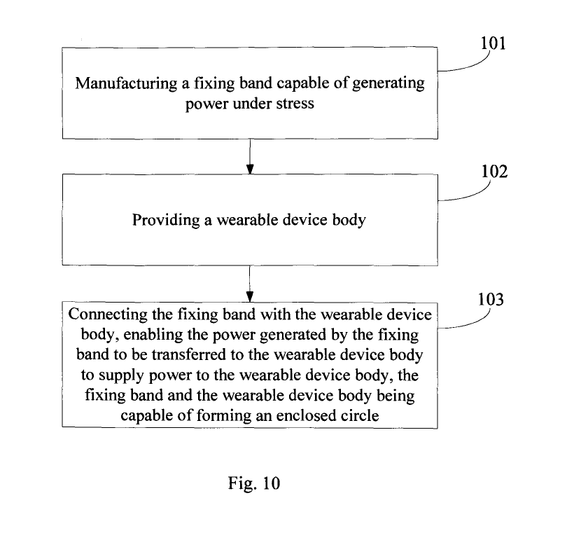

Embodiments of the present disclosure provide a wearable device manufacturing method, as shown in FIG. 10, the method comprising:

Step 101, manufacturing a fixing band capable of generating power under stress;

Step 102, providing a wearable device body;

Step 103, connecting the fixing band to the wearable device body, enabling the power generated by the fixing band to be transferred to the wearable device body to supply power to the wearable device body, the fixing band and the wearable device body being capable of forming an enclosure.

To summarize, embodiments of the present disclosure provide a wearable device manufacturing method, the method comprising the steps of manufacturing the fixing band, providing the wearable device body, and connecting the fixing band to the wearable device body, enabling the power generated by the fixing band to be transferred to the wearable device body to supply power to the wearable device body, thus improving the capability of supplying power to the wearable device body, and reducing cost.

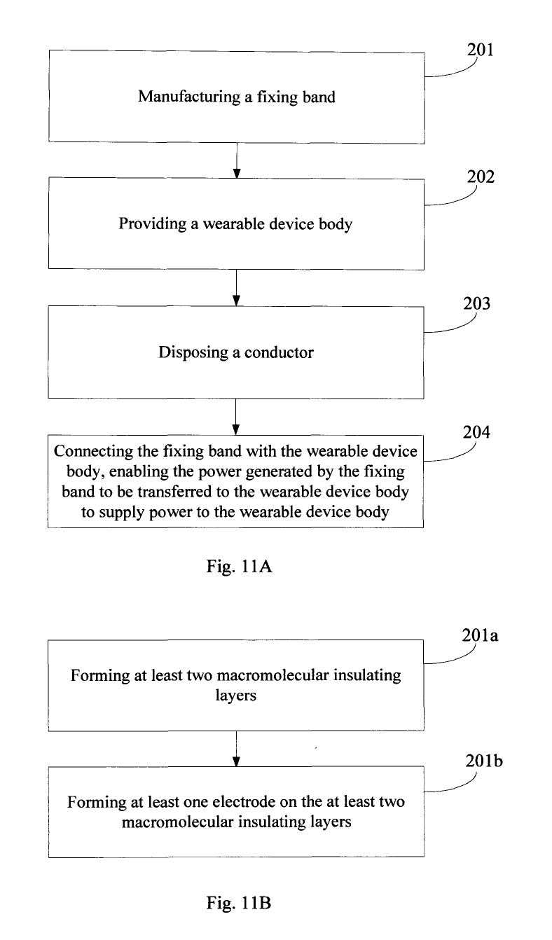

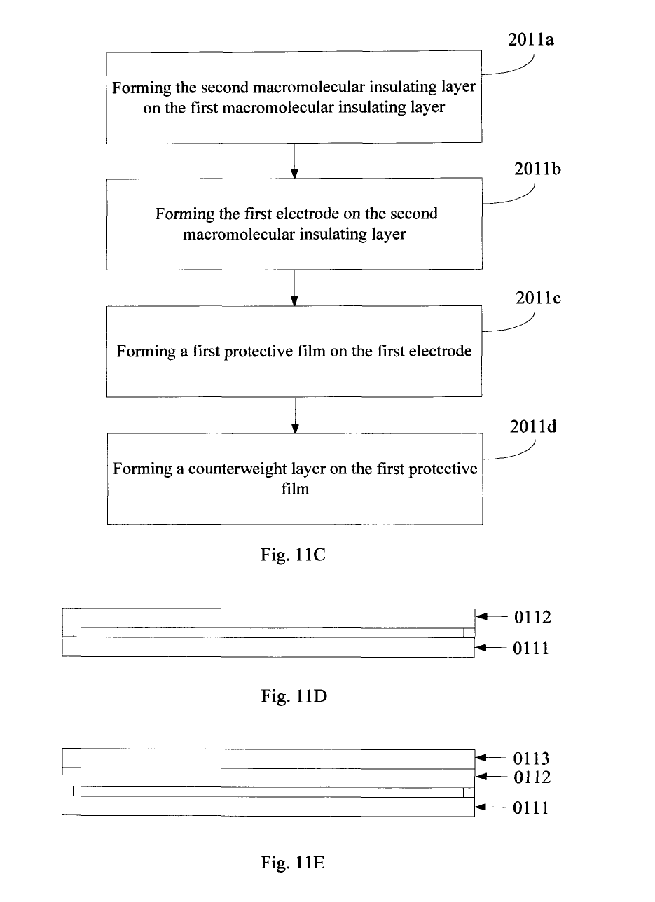

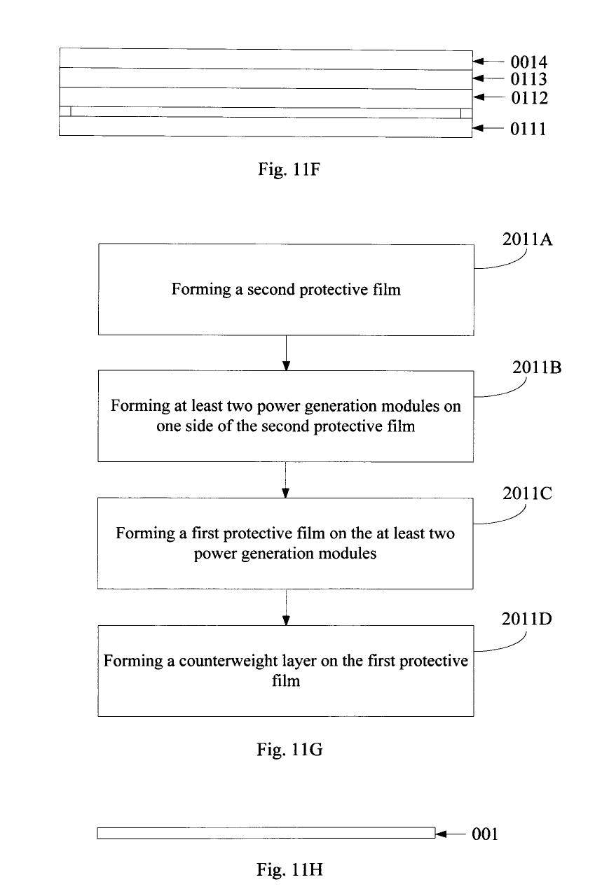

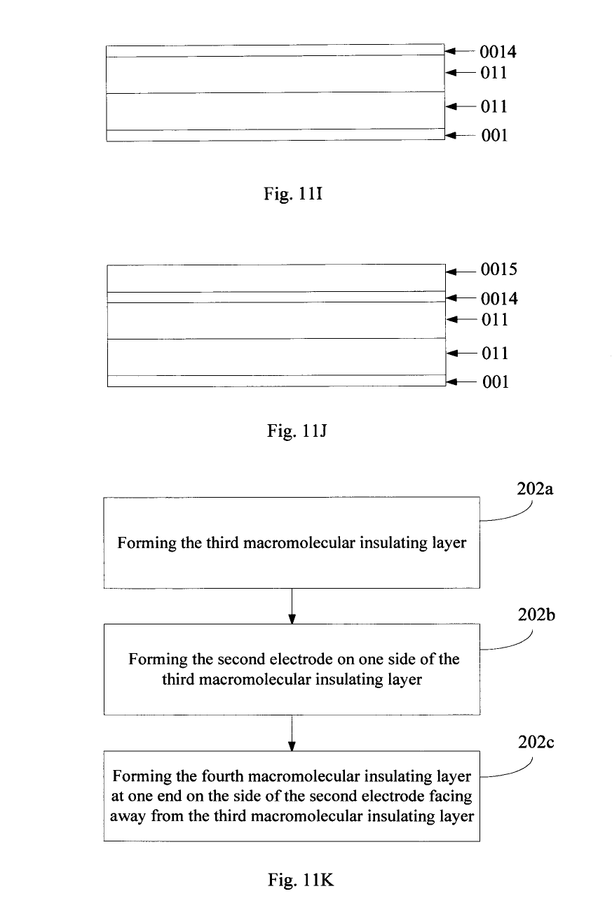

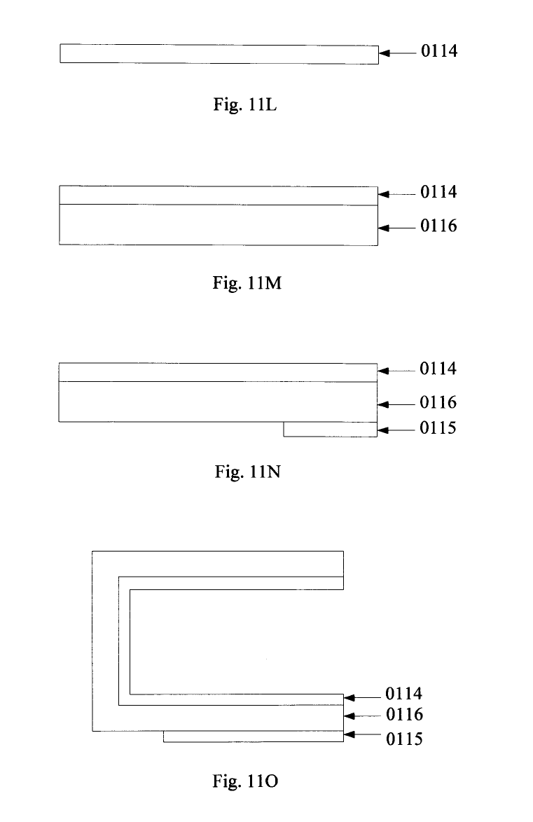

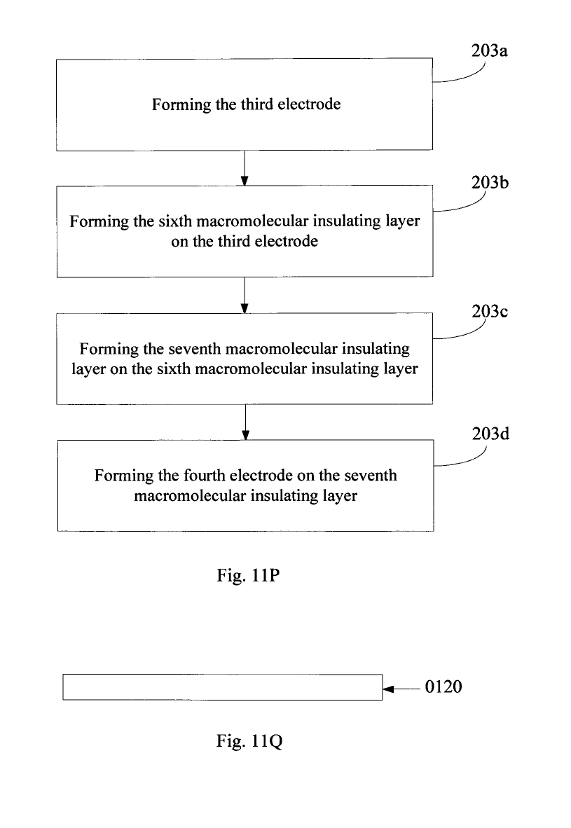

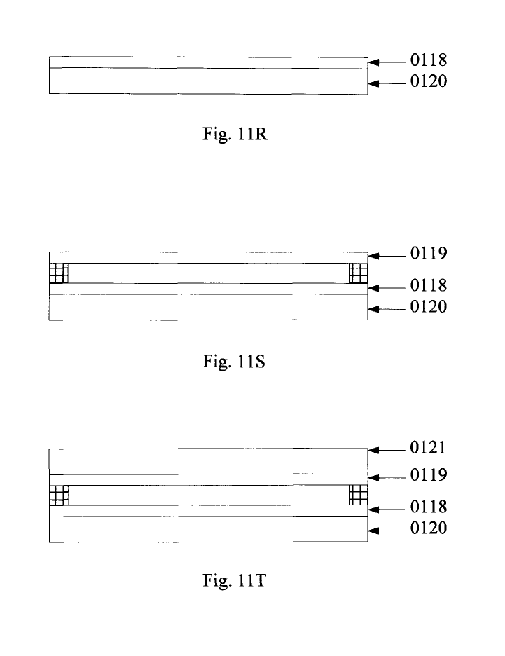

Embodiments of the present disclosure provide another wearable device manufacturing method, as shown in FIG. 11A, the method comprising:

Step 201, manufacturing a fixing band.

The fixing band is configured to generate power under stress.

The step 201 specifically comprises: manufacturing at least one power generation module.

Therein, as shown in FIG. 11B, the process of manufacturing each power generation module comprises:

Step 201a, forming at least two macromolecular insulating layers;

Step 201b, forming at least one electrode on the at least two macromolecular insulating layers.

Since each power generation module comprises macromolecular insulating layers and electrodes, when the fixing band is under stress, the macromolecular insulating layers will become deformed and contact the electrodes, and the two electrodes will generate electrons and thus generate potential difference, such that the fixing band can finally generate power and supply power to the wearable device body.

Optionally, the fixing band may comprise one power generation module; the at least two macromolecular insulating layers in the step 201a comprise a first macromolecular insulating layer and a second macromolecular insulating layer; and the at least one electrode in the step 201b comprises a first electrode. The first macromolecular insulating layer may contact the skin of the wearer. Accordingly, as shown in FIG. 11C, the step 201 comprises:

Step 2011a, forming the second macromolecular insulating layer on the first macromolecular insulating layer.

The second macromolecular insulating layer does not contact the first macromolecular insulating layer. For example, the second macromolecular insulating layer and the first macromolecular insulating layer may be isolated by an isolator, such that the second macromolecular insulating layer does not contact the first macromolecular insulating layer. As shown in FIG. 11D, the second macromolecular insulating layer 0112 is formed on the first macromolecular insulating layer 0111, and does not contact the first macromolecular insulating layer 0111.

Step 2011b, forming a first electrode on the second macromolecular insulating layer.

As shown in FIG. 11E, the first electrode 0113 is formed on the second macromolecular insulating layer 0112. In FIG. 11E, 0111 is the first macromolecular insulating layer. The first electrode acts as one electrode, and the skin of the wearer acts as another electrode. Since the human body is also a conductor, the macromolecular insulating layer, after becoming deformed, will also contact and induce the skin to generate electrons.

Step 2011c, forming a first protective film on the first electrode.

In order to protect the fixing band and ensure the fixing band not easy to be damaged, as shown in FIG. 11F, the first protective film 0014 may also be formed on the first electrode 0113. In FIG. 11F, 0111 is the first macromolecular insulating layer, and 0112 is the second macromolecular insulating layer.

Step 2011d, forming a counterweight layer on the first protective film.

In order to make the macromolecular insulating layers fully contact the skin and the first electrode, such that the skin and the first electrode can generate more electrons to improve the power generation capability of the fixing band, as shown in FIG. 4A, a counterweight layer 0015 may also be formed on the first protective film 0014. The counterweight layer is configured to apply pressure on the first protective film. For example, the counterweight layer may be made of a metal material.

In order to further improve the power generation capability of the fixing band, and ensure the power generated by the fixing band to be better supplied to the wearable device body, for example, the fixing band may comprise at least two power generation modules. Optionally, as shown in FIG. 11G, the step 201 comprises:

Step 2011A, forming a second protective film.

As shown in FIG. 11H, the second protective film 001 is firstly formed.

Step 2011B, forming at least two power generation modules on one side of the second protective film.

As shown in FIG. 5, the at least two power generation modules 011 are formed on one side of the second protective film 001.

Step 2011C, forming a first protective film on the at least two power generation modules.

In order to protect the fixing band and ensure the fixing band is not easily damaged, as shown in FIG. 11I, the first protective film 0014 may also be formed on the at least two power generation modules 011. In FIG. 11I, 001 is the second protective film.

Step 2011D, forming a counterweight layer on the first protective film.

The counterweight layer may apply pressure on the first protective film, such that the power generation modules may generate more electrons to improve the power generation capability of the fixing band. As shown in FIG. 11J, the counterweight layer 0015 is formed on the first protective film 0014. The other reference numerals in FIG. 11J may be explained with reference to the reference numerals in FIG. 11I.

Optionally, FIG. 6 illustrates a specific structural schematic diagram of the fixing band. The at least two macromolecular insulating layers in the step 201a comprise a third macromolecular insulating layer 0114 and a fourth macromolecular insulating layer 0115; and the at least one electrode in the step 201b comprises a second electrode. When manufacturing the fixing band as shown in FIG. 6, the process of manufacturing each power generation module, as shown in FIG. 11K, comprises:

Step 202a, forming the third macromolecular insulating layer.

As shown in FIG. 11L, the third macromolecular insulating layer 0114 is firstly formed.

Step 202b, forming the second electrode on one side of the third macromolecular insulating layer.

As shown in FIG. 11M, the second electrode 0116 is formed on one side of the third macromolecular insulating layer 0114.

Step 202c, forming the fourth macromolecular insulating layer at one end on the side of the second electrode facing away from the third macromolecular insulating layer.

As shown in FIG. 11N, the fourth macromolecular insulating layer 0115 is formed at one end on the side of the second electrode 0116 facing away from the third macromolecular insulating layer 0114.

Further, when manufacturing the fixing band as shown in FIG. 6, the step 201 specifically comprises: bending each power generation module, namely the power generation module as shown in FIG. 11N, towards the center of the third macromolecular insulating layer and forming a C-shaped structure as shown in FIG. 11O. The reference numerals in FIG. 11O may be explained with reference to the reference numerals in FIG. 11N. Then, the C-shaped openings of any two adjacent power generation modules are made to face each other, and one end of one power generation module extends into the C-shaped opening of the other power generation module, wherein the any two adjacent power generation modules do not contact, and the end of any one power generation module where the fourth macromolecular insulating layer is formed does not contact the second protective film. The structure of the fixing band formed is as shown in FIG. 6.

Optionally, FIG. 7 illustrates another specific structural schematic diagram of the fixing band. A fifth macromolecular insulating layer is disposed between any two adjacent power generation modules of the fixing band. The at least two macromolecular insulating layers in the step 201a comprise a sixth macromolecular insulating layer and a seventh macromolecular insulating layer; the at least one electrode in the step 201b comprises a third electrode and a fourth electrode. When manufacturing the fixing band as shown in FIG. 7, the process of manufacturing each power generation module, as shown in FIG. 11P, comprises:

Step 203a, forming the third electrode.

As shown in FIG. 11Q, the third electrode 0120 is firstly formed.

Step 203b, forming the sixth macromolecular insulating layer on the third electrode.

As shown in FIG. 11R, the sixth macromolecular insulating layer 0118 is formed on the third electrode 0120.

Step 203c, forming the seventh macromolecular insulating layer on the sixth macromolecular insulating layer.

The seventh macromolecular insulating layer does not contact the sixth macromolecular insulating layer. For example, the seventh macromolecular insulating layer and the sixth macromolecular insulating layer may be isolated by an isolator, such that the seventh macromolecular insulating layer does not contact the sixth macromolecular insulating layer. As shown in FIG. 11S, the seventh macromolecular insulating layer 0119 is formed on the sixth macromolecular insulating layer 0118, and does not contact the sixth macromolecular insulating layer 0118. In FIG. 11S, 0120 is the third electrode.

Step 203d, forming the fourth electrode on the seventh macromolecular insulating layer.

As shown in FIG. 11T, the fourth electrode 0121 is formed on the seventh macromolecular insulating layer 0119. The other reference numerals in FIG. 11T may be explained with reference to the reference numerals in FIG. 11S.

Step 202, providing a wearable device body.

The provided wearable device body may be any wearable device body in the prior art. For example, the wearable device body may be a watch body.

Step 203, disposing a conductor.

On one hand, the step 203 may comprise: disposing the conductor on the wearable device body at a position capable of contacting the skin of the wearer as shown in FIG. 2. The conductor may receive the power generated by the fixing band and transferred through the skin of the wearer. The power generated by the fixing band is transferred to the wearable device body through the skin of the wearer and the conductor, so as to supply power to the wearable device body.

On the other hand, the step 203 may comprise: disposing the conductor at a connection between the fixing band and the wearable device body as shown in FIG. 3. The fixing band may transfer the power generated by the fixing band to the wearable device body through the conductor. The power generated by the fixing band is directly transferred to the wearable device body through the conductor, so as to supply power to the wearable device body.

Step 204, connecting the fixing band to the wearable device body, enabling the power generated by the fixing band to be transferred to the wearable device body to supply power to the wearable device body.

The fixing band and the wearable device body may form an enclosure. After the fixing band is manufactured, the fixing band and the provided wearable device body are connected. In this way, when the user wears the wearable device on the body, the fixing band may generate power under stress, and the power generated by the fixing band may be transferred to the wearable device body to supply power to the wearable device body.

To summarize, embodiments of the present disclosure provide a wearable device manufacturing method, the method comprising: manufacturing the fixing band, providing the wearable device body, and connecting the fixing band to the wearable device body, enabling the power generated by the fixing band to be transferred to the wearable device body to supply power to the wearable device body, thus improving the capability of supplying power to the wearable device body, and reducing the cost.

Those skilled in the art may clearly understand that, for simplicity and brevity of description, details of the specific processes of the embodiments of the method are omitted here, and reference may be made to the corresponding content of the embodiments of the device described above.

The description above is only preferred embodiments of the present disclosure, and not intended to restrict the present disclosure. Any amendments, equivalent substitutions, improvements and the like within the spirit and principle of the present disclosure are all included in the protection scope of the present disclosure.

1. A wearable device, wherein the wearable device comprises a fixing band and a wearable device body connected to the fixing band, wherein:
the fixing band is configured to generate power under stress;
the power generated by the fixing band is transferable to the wearable device body to supply power to the wearable device body; and
the fixing band and the wearable device body are configured to form an enclosure.

2. The wearable device according to claim 1, further comprising a conductor characterized by one of the following:
the wearable device body is provided with the conductor at a position capable of contacting the skin of a wearer, the conductor configured to receive the power generated by the fixing band and transferred through the skin of the wearer; and
the conductor is disposed at the connection between the fixing band and the wearable device body, and the fixing band is configured to transfer the power generated by the fixing band to the wearable device body through the conductor.

3. (canceled)

4. (canceled)

5. The wearable device according to claim 1, wherein the fixing band comprises a power generation module; the power generation module comprises a first macromolecular insulating layer and a second macromolecular insulating layer;
the first macromolecular insulating layer is positioned to contact the skin of the wearer;
the second macromolecular insulating layer is formed on the first macromolecular insulating layer, and does not contact the first macromolecular insulating layer; and
a first electrode is formed on the second macromolecular insulating layer.

6. The wearable device according to claim 5, wherein
a first protective film is formed on the first electrode.

7. The wearable device according to claim 1, wherein the fixing band comprises at least two power generation modules, each power generation module comprising:
at least two macromolecular insulating layers; and
at least one electrode formed on the at least two macromolecular insulating layers; and
the fixing band further comprises:
a second protective film;
the at least two power generation modules being formed on one side of the second protective film.

8. The wearable device according to claim 7, wherein the at least two macromolecular insulating layers comprise a third macromolecular insulating layer and a fourth macromolecular insulating layer; and the at least one electrode comprises a second electrode; and
each power generation module comprises:
the third macromolecular insulating layer;
the second electrode is formed on one side of the third macromolecular insulating layer;
the fourth macromolecular insulating layer is formed at one end on the side of the second electrode facing away from the third macromolecular insulating layer;
each power generation module bends towards the center of the third macromolecular insulating layer and forms a C-shaped structure; the C-shaped openings of any two adjacent power generation modules face each other, and one end of one power generation module extends into the C-shaped opening of the other power generation module; the any two adjacent power generation modules do not contact each other, and the end of any one power generation module where the fourth macromolecular insulating layer is formed does not contact the second protective film.

9. The wearable device according to claim 7, wherein a fifth macromolecular insulating layer is disposed between any two adjacent power generation modules; the at least two macromolecular insulating layers comprise a sixth macromolecular insulating layer and a seventh macromolecular insulating layer; the at least one electrode comprises a third electrode and a fourth electrode; and each power generation module comprises:
the third electrode;
the sixth macromolecular insulating layer is formed on the third electrode;
the seventh macromolecular insulating layer is formed on the sixth macromolecular insulating layer, and does not contact the sixth macromolecular insulating layer;
the fourth electrode is formed on the seventh macromolecular insulating layer.

10. The wearable device according to claim 7, wherein
a first protective film is formed on the at least two power generation modules.

11. The wearable device according to claim 10, wherein
a counterweight layer is formed on the first protective film, and is configured to apply pressure on the first protective film.

12. The wearable device according to claim 2, wherein the wearable device body comprises a battery and a voltage processing module;
the voltage processing module is for transferring the power received by the conductor to the battery;
the battery is configured to store the power, and to supply the power to the wearable device body.

13. The wearable device according to claim 12, wherein the voltage processing module comprises a voltage lowering sub-module, a rectification sub-module and a buck circuit, the voltage lowering sub-module being electrically connected to the conductor and the rectification sub-module respectively, and the buck circuit being electrically connected to the rectification sub-module and the battery respectively;
the voltage lowering sub-module is configured to lower the output voltage received by the conductor to obtain a lowered AC voltage;
the rectification sub-module is configured to rectify the lowered AC voltage to obtain a DC voltage;
the buck circuit is configured to lower the DC voltage to obtain a lowered DC voltage, and to transfer the lowered DC voltage to the battery

14. (canceled)

15. A wearable device manufacturing method, wherein the method comprises:
manufacturing a fixing band capable of generating power under stress;
providing a wearable device body;
connecting the fixing band to the wearable device body, such that the power generated by the fixing band is transferable to the wearable device body to supply power to the wearable device body, the fixing band and the wearable device body being capable of forming an enclosure.

16. The method according to claim 15, wherein the method further comprises disposing a conductor according to one of the following:
disposing the conductor on the wearable device body at a position capable of contacting the skin of the wearer, the conductor being capable of receiving the power generated by the fixing band and transferred through the skin of the wearer; and
disposing the conductor at the connection between the fixing band and the wearable device body, the fixing band being capable of transferring the power generated by the fixing band to the wearable device body through the conductor.

17. (canceled)

18. (canceled)

19. The method according to claim 15, wherein manufacturing the fixing band comprises one manufacturing a power generation module; and wherein
manufacturing the power generation module comprises:
forming a second macromolecular insulating layer on a first macromolecular insulating layer, wherein the first macromolecular insulating layer is positioned to contact the skin of the wearer, and the second macromolecular insulating layer does not contact the first macromolecular insulating layer; and
forming a first electrode on the second macromolecular insulating layer.

20. The method according to claim 19, wherein after forming the first electrode on the second macromolecular insulating layer, manufacturing the fixing band further comprises:
forming a first protective film on the first electrode.

21. The method according to claim 15, wherein manufacturing the fixing band further comprises:
forming a second protective film;
forming at least two power generation modules on one side of the second protective film.

22. The method according to claim 21, wherein
forming each power generation module comprises:
forming a third macromolecular insulating layer;
forming a second electrode on one side of the third macromolecular insulating layer;
forming a fourth macromolecular insulating layer at one end on the side of the second electrode facing away from the third macromolecular insulating layer; and
manufacturing the fixing band further comprises:
bending each power generation module towards the center of the third macromolecular insulating layer and forming a C-shaped structure, the C-shaped openings of any two adjacent power generation modules facing each other, and one end of one power generation module extending into the C-shaped opening of the other power generation module;
wherein the any two adjacent power generation modules do not contact, and the end of any one power generation module where the fourth macromolecular insulating layer is formed does not contact the second protective film.

23. The method according to claim 21, wherein
forming each power generation module comprises:
forming a third electrode;
forming a sixth macromolecular insulating layer on the third electrode;
forming a seventh macromolecular insulating layer on the sixth macromolecular insulating layer, wherein the seventh macromolecular insulating layer does not contact the sixth macromolecular insulating layer; and
forming a fourth electrode on the seventh macromolecular insulating layer.

24. The method according to claim 21, wherein after forming the at least two power generation modules on one side of the second protective film, manufacturing the fixing band further comprises:
forming a first protective film on the at least two power generation modules.

25. The method according to claim 20, wherein manufacturing the fixing band further comprises:
forming a counterweight layer on the first protective film, the counterweight layer capable of applying pressure on the first protective film.
